(19) United States
(12) Patent Application Publication
(10) Pub. No.: US 2023/0392234 A1
(43) Pub. Date: Dec. 7, 2023

(54) High-Temperature Alloy Having Low Stacking Fault Energy, Structural Member And Application Thereof

(71) Applicant: GAONA AERO MATERIAL CO., LTD, Beijing (CN)

(72) Inventors: Zhongnan Bi, Beijing (CN); Hongyao Yu, Beijing (CN); Jinhui Du, Beijing (CN); Hailong Qin, Beijing (CN); Bin Gan, Beijing (CN)

(73) Assignee: GAONA AERO MATERIAL CO., LTD, Beijing (CN)

(21) Appl. No.: 18/033,261

(22) PCT Filed: May 27, 2021
(86) PCT No.: PCT/CN2021/096494

§ 371 Date: Apr. 21, 2023

(30) Foreign Application Priority Data
Apr. 22, 2021 (CN) 202110433365.3

(51) Int. Cl. C22C 19/05

(52) U.S. Cl. CPC C22C 19/056

(57) ABSTRACT

A superalloy with low stacking fault energy includes by mass fraction 0.01%˜0.09% of C, 23.5%˜27.5% of Co, 11%˜15% of Cr, 0.1%˜1.8% of W, 2.2%˜2.6% of Al, 3.5%˜5.5% of Ti, 0%˜2% of Nb, 0%˜2% of Ta, 2.1%˜3.5% of Mo, 0.0001%˜0.05% of B, 0.0001%˜0.05% of Zr, 0%˜2.5% of Fe, 0%˜0.04% of Mg, 0%˜0.02% of Hf, and a balance of Ni, wherein a sum of the mass fractions of Nb and Ta is ≥0.8%. The superalloy is capable of service performance above 750° C. and good thermal processing characteristics, and is usable for structural members for long-term use, for example a turbine disc, a blade, a casing, a combustion chamber, etc. The superalloy has a structural member and an application thereof.

### CROSS-REFERENCE TO RELATED APPLICATION

The present application claims the priority to a Chinese patent application No. 2021104333653, filed with the Chinese Patent Office on Apr. 22, 2021 and entitled “HIGH-TEMPERATURE ALLOY HAVING LOW STACKING FAULT ENERGY, STRUCTURAL MEMBER AND APPLICATION THEREOF” the content of which is incorporated herein by reference in entirety.

### TECHNICAL FIELD

The present application relates to the technical field of superalloy, in particular to a superalloy with low stacking fault energy (or a high-temperature alloy having low stacking fault energy), structural member and use thereof.

### BACKGROUND ART

Like the “heart” of the aircraft, the aviation engine is known as “jewel on the crown” among high-end manufacturing industries. Superalloy are foundations of the aviation engine, as well as key materials for important weapons and equipment such as aerospace vehicles and naval gas turbines. In particular, due to their excellent service performance and also good process applicability, a general-purpose superalloy can enable “one material with multiple uses” with outstanding cost performance, and has been widely used in fields such as aviation, aerospace and naval vessel.

IN718 alloy, which is the representative of the general-purpose superalloys at this stage, is the most consumed and most versatile core superalloy in various fields. In recent years, as the aviation engine and the aerospace vehicle have demanded increasingly more in the performance level, on the one hand, there is a need for the new generation of superalloy to increase the temperature bearing capacity of 100° C., and on the other hand, there is also a need for it to have good process characteristics to make parts and components with increasingly complex structures, achieving the goal of reducing weight and increasing efficiency. Taking the new generation of aviation engines as an example, the whole bladed disc at the final stage of the high-pressure compressor has reached the service temperature of 750° C. However, the IN718 alloy has only a stable use temperature of 650° C., and can no longer meet the requirements of use with its temperature bearing capacity and performance level.

In order to improve the temperature bearing capacity and the mechanical performance of alloys, the redissolution temperature and the volume fraction of the strengthening phase are mainly improved by increasing the alloying degree of materials. However, this method tends to increase the tendency of alloy segregation, and narrow the window for thermal processing, leading to increases in the difficulty in thermal processing. Moreover, cracking occurs easily in the course of the welding and after the welding. Thus, the scope of the application of this method is limited greatly. On the other hand, additive manufacturing (3D printing) technology, which can significantly improve the capacity for forming complex components and the efficiency for producing a single-piece, is an advanced manufacturing technology that has developed rapidly in recent years, and has been widely used particularly in high-speed aircrafts. However, this technology is highly dependent on the processability, especially weldability, of the alloy materials. At present, the alloys that can be formed by 3D printing have insufficient strength and temperature bearing capacity, and the high-performance superalloy grades have cracking occurred easily and are difficult to print, resulting in no materials available in design. Therefore, it is an object of the present application to develop a general-purpose superalloy with both high performance and good process performance.

In view of the above, the present application is hereby proposed.

### SUMMARY

An object of the present application includes, for example, providing a superalloy with low stacking fault energy, so as to solve the technical problem in the prior art that the service performance is conflicting with the making process characteristics.

An object of the present application includes, for example, providing a structural member made of the superalloy with low stacking fault energy.

An object of the present application includes, for example, providing use of the structural member made of the superalloy with low stacking fault energy.

In order to achieve the above objects of the present application, the following technical solutions are particularly adapted.

A superalloy with low stacking fault energy may include: by mass fraction, 0.01%˜0.09% of C, 23.5%˜27.5% of Co, 11%˜15% of Cr, 0.1%˜1.8% of W, 2.2%˜2.6% of Al, 3.5%˜5.5% of Ti, 0%˜2% of Nb, 0%˜2% of Ta, 2.1%˜3.5% of Mo, 0.0001%˜0.05% of B, 0.0001%˜0.05% of Zr, 0%˜2.5% of Fe, 0%˜0.04% of Mg, and a balance of Ni,
where a sum of the mass fractions of Nb and Ta is 10.8%.

The method for strengthening the high-performance superalloy is mainly to strengthen the precipitated phase in combination with the solid solution strengthening and the grain boundary strengthening to obtain a comprehensive high-temperature performance. However, in the case of using only the above method for strengthening, the means used to continue to improve the alloy performance is generally to increase the alloying degree of the material, but the means used will bring about a deterioration of the process performance, and also cannot meet the requirements on both a high performance and a good process performance.

It was found during the exploration of the present application that microstructures such as micro-twinning occur easily during the deformation process when the stacking fault energy of the matrix in the superalloy is reduced, and the mechanical performance of the alloy can be improved apparently during the service process when the micro-twinning and the like and the precipitated phase cooperate synergistically; and optionally, by simultaneously adjusting strengthening phase element, a general-purpose superalloy with both high performance and a good process performance can be obtained.

The superalloy with low stacking fault energy of the present application can have service performance above 750° C. and good thermal processing, welding, and 3D printing, and other characteristics, and can be used as structural members for long-term use, for example, a turbine disc, a blade, a casing (cartridge receiver), a combustion chamber, and the like.

In the present application, by adding Nb and Ta, the precipitation rate of the strengthening phase is slowed down, the redissolution temperature of the strengthening phase is reduced, and the γ single-phase region is enlarged, so that the alloy has an excellent thermal deformation process performance.

In a specific embodiment of the present application, in the superalloy with low stacking fault energy, the mass fraction of Co is 23.5%˜26.5%, preferably 24%˜26%.

An increase in the content of Co in the superalloy can effectively reduce the stacking fault energy of the γ matrix and the micro-twinning easily occurs. When the micro-twinning and γ′ phases are strengthened synergistically, the performance of the material can be effectively improved. However, the addition of excessive Co element will not continue to significantly reduce the stacking fault energy but will have the problem of increased alloy cost at the same time. In the present application, by using the above content of Co in cooperation with other ingredients, the stacking fault energy can be reduced, and a good performance can be obtained.

In a specific embodiment of the present application, in the superalloy with low stacking fault energy, the mass fraction of C is 0.01%˜0.06%, preferably 0.01%˜0.04%, and more preferably 0.01%˜0.02%.

The addition of the C element to the superalloy may segregate in the grain boundary and increase the grain boundary strength; and it will also form carbides like MC, M6C, or M23C6, which hinder the movement of dislocations under high-temperature conditions and perform function of high-temperature strengthening. However, an excessive content of C will cause carbides to be precipitated at the grain boundary and form a continuous carbide film, which is not good to the mechanical performance of the alloy. The present application can ensure the high-temperature strengthening effect and mechanical performance of the alloy by adjusting the content of C within the above range, in cooperation with other elements.

In a specific embodiment of the present application, in the superalloy with low stacking fault energy, the mass fraction of Cr is 12%˜14%, preferably 12%˜13%.

The addition of the Cr element can effectively reduce the stacking fault energy of the matrix of the alloy, and can also perform a function of solid solution strengthening, and thus may improve the high-temperature mechanical performance of the material. Also, the addition of the Cr element can form a dense oxide film on the surface of the metal under high-temperature conditions, so as to improve the oxidation resistance performance of the alloy. However, if the content of Cr exceeds 16%, the precipitation of harmful secondary phases will be facilitated greatly, which will affect the high-temperature mechanical performance of the alloy. Therefore, in the present application, it is preferable to adjust the content of Cr within 12%˜13% in order to take into account performances in various aspects.

In a specific embodiment of the present application, in the superalloy with low stacking fault energy, the sum of the mass fractions of W and Mo is 3%, preferably %.

In a specific embodiment of the present application, the mass fraction of W is 1%˜1.8%, more preferably 1%˜1.5%, and further preferably 1.1%˜1.3%; and the mass fraction of Mo is 2.1%˜3.0%, more preferably 2.5%˜3.0%, and further preferably 2.7%˜2.9%.

The addition of W has a solid solution-strengthening effect on both γ and γ′ phases. However, an excessive content of W increases the tendency of precipitating a harmful phase such as p phase on the one hand; and increases the overall density of the alloy, limiting the application of the alloy on the other hand. Therefore, in the present application, the content of W is adjusted within the above range to ensure performance. Similar to the effect of W, Mo preferentially enters the γ phase and performs a function of solid solution strengthening in the nickel-based superalloy. However, excessive content of Mo will increase the tendency of precipitating harmful phases such as σ phase and μ phase, resulting in a decrease in alloy performance. By adjusting the content of W and Mo within the above range, the precipitation and the coarsening of the TCP phase are avoided, and a good solid solution-strengthening effect is also obtained.

In a specific embodiment of the present application, the sum of the mass fractions of Al, Ti, Nb, and Ta is %.

In a specific embodiment of the present application, in the superalloy with low stacking fault energy, the mass fraction of Al is 2.3%˜2.5%.

In the superalloy, the Al element is the forming element of γ′ strengthening phase; as the content of the Al element increases, on the one hand, the volume fraction of γ′ strengthening phase can be increased to obtain excellent high-temperature performance; and on the other hand, it can also reduce the alloy density to increase its scope of application. However, a higher content of Al will increase the redissolution temperature of the γ′ phase and narrow the window for thermal processing, which will damage the thermal processing characteristics of the alloy. Therefore, the present application can ensure the thermal processing characteristics of the alloy while improving the high-temperature performance and reducing the density, by adjusting the Al content within the range of 2.3%˜2.5%.

In a specific embodiment of the present application, in the superalloy with low stacking fault energy, the mass fraction of Ti is 4.4%˜4.6%. In the superalloy, the Ti element is also the forming element of γ′ strengthening phase; as the content of the Ti element increases, the volume fraction of γ′ strengthening phase can also be increased to obtain excellent high-temperature performance. However, the risk of precipitating q phase will increase along with the increased Ti content, which reduces the performance of the alloy.

In a specific embodiment of the present application, in the superalloy with low stacking fault energy, a ratio of a sum of the mass fractions of Nb and Ta to the mass fraction of the Al element is 13.4; and a ratio of the mass fraction of Ti to the mass fraction of Al is 2.1. Optionally, the mass fraction of Nb is %˜1.5%; and the mass fraction of Ta is 0.1%˜2.0%. The addition of the Nb element can effectively reduce the precipitation rate of the γ′ strengthening phase, and can also reduce the redissolution temperature of the γ′ strengthening phase at the same time, which is beneficial to the thermal deformation process. However, excessive content of Nb will adversely affect the crack growth resistance of the material. The addition of the Ta element can increase the anti-phase domain boundary energy to increase the strength of the alloy; at the same time, it also reduces the γ′ redissolution temperature, which is good for the thermal processing performance of the alloy. But Ta will increase the risk of precipitating TCP phase, and increase alloy density and cost. In connection with the effect of the above Al element and Ti element in the alloy system, by adjusting the content of Nb within 0.5%˜1.5% and the content of Ta within 0.1%˜2.0%, and requiring a ratio of a sum of the mass fractions of Nb and Ta to the mass fraction of Al element ≥0.4 and the ratio of the mass fraction of Ti to the mass fraction of Al ≤2.1, the thermal processing performance of the alloy and the mechanical performance of the alloy can be considered and improved in many aspects.

In the alloy of the present application, the mass fraction of the added Fe element does not exceed 2.5%, which can effectively reduce the alloy cost without excessively affecting the overall performance level of the alloy, and allows the addition of return materials such as solid waste and machining debris during the alloy manufacturing process.

In a specific embodiment of the present application, in the superalloy with low stacking fault energy, the mass fraction of B is 0.001%˜0.03%, and the mass fraction of Zr is 0.001%˜0.03%. Both B and Zr elements segregate in the grain boundary and can improve the thermoplasticity and the high-temperature creep strength of the alloy, but the B element is easy to form a low melting point phase of boride, and an excessive content of Zr increases the process difficulty in obtaining a homogenized ingot. Specific content of B and Zr used can improve the performance of the alloy and improve the processing process.

In a specific embodiment of the present application, in the superalloy with low stacking fault energy, the volume fraction of γ′ strengthening phase is above %, preferably 40%˜55%, and more preferably 40%˜50%.

An excessive volume fraction of the γ′ strengthening phases such as 55% or even higher obtains a higher high-temperature strength but has its thermal deformation process performance reduced, rendering it difficult to make a large-size forging member. In the present application, comprehensively considering the high-temperature performance level and the thermal deformation process performance of the alloy, the volume fraction of the γ′ strengthening phase preferably reaches above 40%; and moreover, in connection with the strengthening mechanism such as micro-twinning, the γ′ phase, and the micro-twinning are strengthened synergistically, obtaining the superalloy with excellent high-temperature performance.

In a specific embodiment of the present application, a superalloy with low stacking fault energy may include: by a mass fraction, 0.01%˜0.04% of C, 24%˜26% of Co, 12%˜14% of Cr, 1%˜1.5% of W, 2.5%˜3.0% of Mo, 2.3%˜2.5% of Al, 4.4%˜4.6% of Ti, 0.5%˜1.5% of Nb, 0.1%˜2.0% of Ta, %˜0.03% of B, 0.001%˜0.03% of Zr, 0%˜2.5% of Fe, 0%˜0.04% of Mg, and a balance of Ni. Preferably, a superalloy with low stacking fault energy may include: by a mass fraction, 0.01%˜0.02% of C, 24%˜26% of Co, 12%˜14% of Cr, 1%˜1.5% of W, 2.5%˜3.0% of Mo, 2.3%˜2.5% of Al, 4.4%˜4.6% of Ti, 0.5%˜1.5% of Nb, 0.1%˜2.0% of Ta, 0.001%˜0.03% of B, 0.001%˜0.03% of Zr, 0%˜2.5% of Fe, 0%˜0.04% of Mg, and a balance of Ni. More preferably, a superalloy with low stacking fault energy may include: by a mass fraction, 0.01%˜0.02% of C, 24%˜26% of Co, 12%˜13% of Cr, 1.1%˜1.3% of W, 2.7%˜2.9% of Mo, 2.3%˜2.5% of Al, 4.4%˜4.6% of Ti, %˜1.5% of Nb, 0.1%˜2.0% of Ta, 0.001%˜0.03% of B, 0.001%˜0.03 of Zr, 0%˜2.5% of Fe, and a balance of Ni.

The present application further provides a structural member made of any one of the above superalloy with low stacking fault energy.

In a specific embodiment of the present application, the structural member may include any one of a forging member, a casting member, and an additively manufactured structural member.

In a specific embodiment of the present application, a method for making the forging member may include:
(a) dosing according to ingredients of the superalloy with low stacking fault energy, smelting the mixture to obtain an ingot; and
(b) performing homogenizing processing on the ingot, then making the same forged into a shape, and then performing thermal processing.

In a specific embodiment of the present application, a method for making the casting member may include:
dosing according to ingredients of the superalloy with low stacking fault energy, performing a vacuum induction smelting, and performing thermal processing after casting.

In a specific embodiment of the present application, a method for making the additively manufactured structural member may include:
(a) dosing according to ingredients of the superalloy with low stacking fault energy, smelting the mixture to obtain an electrode rod, pulverizing the same, and then performing 3D printing according to the preset model; and
(b) performing hot isostatic pressing processing and thermal processing on the profile obtained by 3D printing.

The present application further provides the use of any one of the above structural members in aviation and aerospace equipment.

Compared with the prior art, the present application brings about the following beneficial effects:
(1) in the superalloy with low stacking fault energy of the present application, the content of Co is increased to a certain extent, solid solution elements such as Mo and W are optimized, the ratio of the strengthening phase elements of Al, Ti, Nb, and Ta is adjusted, and an appropriate amount of trace elements such as C and B are also added, so that the stacking fault energy of the matrix can be effectively reduced and the introduction of micro-twinning in the subsequent thermal deformation process can be facilitated, wherein micro-twinning and γ′ phase are strengthened synergistically, in combination with the grain boundary strengthening effect, the temperature bearing capacity and the high-temperature strength of the alloy can be effectively improved; on the other hand, the adjustment of the strengthening phase elements can effectively slow down the precipitation rate of the strengthening phase, reduce the redissolution temperature of the strengthening phase, expand the window for thermal processing, and effectively improve the process performance of the alloy while ensuring a sufficient number of strengthening phases, so that the alloy has service performance above 750° C. and good thermal processing, welding and 3D printing characteristics; and
(2) the superalloy with low stacking fault energy of the present application can be cast, forged, welded, printed, and so on; it has an excellent process performance and can be suitable for making a structural member in aviation and aerospace equipment, for example, it can be used as structural members for long-term use, for example, a turbine disc, a blade, a casing, and a combustion chamber.

### BRIEF DESCRIPTION OF DRAWINGS

Drawings required for use in the description of specific embodiments or the prior art will be introduced briefly below to explain the technical solutions of the specific embodiments of the present application or of the prior art more clearly. It will be apparent that the drawings described below are merely illustrative of some embodiments of the present application. Those skilled in the art can also obtain, from these drawings, other drawings without inventive efforts.

FIG. 1 is a typical microstructure diagram of a superalloy according to an example of the present application.

### DETAILED DESCRIPTION OF THE EMBODIMENTS

The technical solutions of the present application will be described clearly and completely below concerning the drawings and the specific embodiments. However, those skilled in the art would appreciate that the following examples described are some, but not all, examples of the present application, and are only for illustrating the present application, and shall not be construed as limiting the scope of the present application. All the other embodiments obtained by those skilled in the art in light of the embodiments of the present application without inventive efforts will fall within the claimed scope of the present application. If no specific conditions are specified in the example, the general conditions or the conditions recommended by the manufacturer shall apply. If not indicated by the manufacturer, the reagents or instruments used are conventional products commercially available.

A superalloy with low stacking fault energy includes, by a mass fraction: 0.01%˜0.09% of C, 23.5%˜27.5% of Co, 11%˜15% of Cr, 0.1%˜1.8% of W, 2.2%˜2.6% of Al, 3.5%˜5.5% of Ti, 0%˜2% of Nb, 0%˜2% of Ta, 2.1%˜3.5% of Mo, 0.0001%˜0.05% of B, 0.0001%˜0.05% of Zr, 0%˜2.5% of Fe, 0%˜0.04% of Mg, and a balance of Ni,
where a sum of Nb and Ta mass fractions is 10.8%.

The superalloy with low stacking fault energy of the present application can both have service performance above 750° C. and good thermal processing, welding and 3D printing and other characteristics. It can be used as structural members for long-term use for example, a turbine disc, a blade, a casing, a combustion chamber, and the like.

For example, in different embodiments, the mass fraction of each component can be as follows, respectively:
the mass fraction of C may be 0.01%, 0.02%, 0.03%, 0.04%, 0.05%, %, 0.07%, 0.08%, 0.09%, etc.;
the mass fraction of Co can be 23.5%, 24%, 24.5%, 25%, 25.5%, 26%, 26.5%, 27%, 27.5%, etc.;
the mass fraction of Cr can be 11%, 12%, 12.5%, 13%, 13.5%, 14%, %, etc.;
the mass fraction of W can be 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, etc.;
the mass fraction of Mo can be 2.1%, 2.2%, 2.5%, 2.8%, 3%, 3.2%, 3.5%, etc.;
the mass fraction of Al can be 2.2%, 2.3%, 2.4%, 2.5%, 2.6%, etc.;
the mass fraction of Ti can be 3.5%, 3.8%, 4%, 4.2%, 4.5%, 4.8%, 5%, %, 5.5%, etc.;
the mass fraction of Nb can be 0.5%, 0.8%, 1%, 1.2%, 1.5%, 1.8%, 2%, etc.;
the mass fraction of Ta can be 0.1%, 0.2%, 0.5%, 0.8%, 1%, 1.2%, 1.5%, 1.8%, 2%, etc.;
the mass fraction of B can be 0.0001%, 0.0005%, 0.001%, 0.005%, 0.01%, %, 0.02%, 0.025%, 0.03%, 0.035%, 0.04%, 0.045%, 0.05%, etc.;
the mass fraction of Zr can be 0.0001%, 0.0005%, 0.001%, 0.005%, 0.01%, %, 0.02%, 0.025%, 0.03%, 0.035%, 0.04%, 0.045%, 0.05%, etc.;
the mass fraction of Fe can be 0%, 0.1%, 0.2%, 0.5%, 0.8%, 1%, 1.2%, 1.5%, 1.8%, 2%, 2.2%, 2.5%, etc.; and
the mass fraction of Mg can be 0%, 0.01%, 0.02%, 0.03%, 0.04%, etc.

In a specific embodiment of the present application, in the superalloy with low stacking fault energy, the mass fraction of Co is 23.5%˜26.5%, preferably 24%˜25%.

An increase in Co content in the superalloy can effectively reduce the stacking fault energy of the γ matrix and the micro-twinning easily occur. When the micro-twinning and γ′ phases are strengthened synergistically, the performance of the material can be effectively improved. However, the addition of excessive Co element will not continue to reduce the stacking fault energy significantly. Still, it will have the problem of increased alloy cost at the same time. In the present application, by using the above content of Co in cooperation with other ingredients, the stacking fault energy can be reduced, and a good performance can be obtained.

In a specific embodiment of the present application, in the superalloy with low stacking fault energy, the mass fraction of C is 0.01%˜0.06%, preferably %˜0.04%, and more preferably 0.01%˜0.02%.

The addition of the C element to the superalloy may segregate in the grain boundary and increase the grain boundary strength; it will also form carbides like MC, M6C, or M23C6, which hinder the movement of dislocations under high-temperature conditions and perform a function of high-temperature strengthening. However, an excessive content of C will cause carbides to be precipitated at the grain boundaries and form a continuous carbide film, which is not good for the mechanical performance of the alloy. The present application can ensure the high-temperature strengthening effect and the mechanical performance of the alloy by adjusting the content of C within the above range in combination with other elements.

In a specific embodiment of the present application, in the superalloy with low stacking fault energy, the mass fraction of Cr is 12%˜14%, preferably 12%˜13%.

The addition of the Cr element can effectively reduce the stacking fault energy of the matrix of the alloy, and can also perform a function of solid solution strengthening, so that the high-temperature mechanical performance of the material can be improved. Also, the addition of the Cr element can form a dense oxide film on the surface of the metal under high-temperature conditions to improve the oxidation resistance performance of the alloy. However, if the content of Cr exceeds 16%, the precipitation of harmful secondary phases will be significantly facilitated, which will affect the high-temperature mechanical performance of the alloy. Therefore, in the present application, it is preferable to adjust the content of Cr within 12%˜13% to take into account performances in various aspects.

In a specific embodiment of the present application, in the superalloy with low stacking fault energy, the sum of the mass fractions of W and Mo is 3%, preferably %.

In a specific embodiment of the present application, the mass fraction of W is 1%˜1.8%, more preferably 1%˜1.5%, and further preferably 1.1%˜1.3%; and the mass fraction of Mo is 2.1%˜3.0%, more preferably 2.5%˜3.0%, and further preferably 2.7%˜2.9%.

Adding W has a solid solution-strengthening effect on both γ and γ′ phases. However, excessive content of W will increase the tendency of precipitating a harmful phase such as p phase on the one hand; and increase the overall density of the alloy, limiting the application of the alloy on the other hand. Therefore, in the present application, the content of W is adjusted within the above range to ensure performance. Similar to the effect of W, Mo preferentially enters the γ phase and performs a function of solid solution strengthening in the nickel-based superalloy. However, excessive content of Mo will increase the tendency of precipitating harmful phases such as σ phase and μ phase, resulting in a decrease in alloy performance. By adjusting the contents of W and Mo within the above range, the precipitation and coarsening of the TCP phase are avoided, and also a good solid solution-strengthening effect is obtained.

In a specific embodiment of the present application, the sum of the mass fractions of Al, Ti, Nb, and Ta is 7%.

In a specific embodiment of the present application, in the superalloy with low stacking fault energy, the mass fraction of Al is 2.3%˜2.5%.

In the superalloy, the Al element is the forming element of γ′ strengthening phase; as the content of the Al element increases, on the one hand, the volume fraction of γ′ strengthening phase can be increased to obtain an excellent high-temperature performance. On the other hand, it can also reduce the alloy density to increase its scope of application. However, a higher content of Al will increase the redissolution temperature of the γ′ phase and narrow the window for thermal processing, which will damage the thermal processing characteristics of the alloy. Therefore, the present application can ensure the thermal processing characteristics of the alloy while improving the high-temperature performance and reducing the density, by adjusting the Al content within the range of 2.3%˜2.5%.

In a specific embodiment of the present application, in the superalloy with low stacking fault energy, the mass fraction of Ti is 4.4%˜4.5%. In the superalloy, the Ti element is also the forming element of γ′ strengthened phase; as the content of the Ti element increases, the volume fraction of γ′ strengthening phase can also be increased to obtain an excellent high-temperature performance. However, the risk of precipitating η phase will increase along with the Ti content, which reduces the performance of the alloy.

In a specific embodiment of the present application, in the superalloy with low stacking fault energy, a ratio of a sum of the mass fractions of Nb and Ta to the mass fraction of the Al element is ≥0.4; and a percentage of the mass fraction of Ti to the mass fraction of Al is ≤2.1. Optionally, the mass fraction of Nb is 0.5%˜1.5%; and the mass fraction of Ta is 0.1%˜2.0%. The addition of the Nb element can effectively reduce the precipitation rate of the γ′ strengthening phase and reduce the redissolution temperature of the γ′ strengthening phase simultaneously, which is beneficial to the thermal deformation process. However, excessive content of Nb will adversely affect the crack growth resistance of the material. Adding the Ta element can increase the anti-phase domain boundary energy to increase the strength of the alloy; at the same time, it also reduces the γ′ redissolution temperature, which is good for the thermal processing performance of the alloy. But Ta will increase the risk of precipitating TCP phase, and increase alloy density and cost. In connection with the effect of the above Al element and Ti element in the alloy system, by adjusting the content of Nb within 0.5%˜1.5% and the content of Ta within 0.1%˜2.0%, and requiring the ratio of a sum of the mass fractions of Nb and Ta to the mass fraction of Al element ≥0.4 and the ratio of the mass fraction of Ti to the mass fraction of Al ≤2.1, the thermal processing performance of the alloy and the mechanical performance of the alloy can be considered and improved in many aspects.

In the alloy of the present application, the mass fraction of the added Fe element does not exceed 2.5%, which can effectively reduce the alloy cost without excessively affecting the overall performance level of the alloy and allows the addition of return materials such as solid waste and machining debris during the alloy manufacturing process.

In a specific embodiment of the present application, in the superalloy with low stacking fault energy, the mass fraction of B is 0.001%˜0.03%, and the mass fraction of Zr is 0.001%˜0.03%. Both B and Zr elements segregate in the grain boundary and can improve the thermoplasticity, and the high-temperature creep strength of the alloy. Still, the B element is easy to form a low melting point phase of boride, and an excessive content of Zr element increases the process difficulty in obtaining a homogenized ingot. The specific content of B and Zr used can improve the performance of the alloy and improve the processing process.

In a specific embodiment of the present application, in the superalloy with low stacking fault energy, the volume fraction of γ′ strengthening phase is above 30%, preferably 40%˜55%, and more preferably 40%˜50%.

An excessive volume fraction of the γ′ strengthening phase such as 55% or even higher obtains a higher high-temperature strength, but has its thermal deformation process performance reduced, rendering difficult to prepare a large-size forging member. In the present application, considering both the high-temperature performance level and the thermal deformation process performance of the alloy, the volume fraction of the γ′ strengthening phase preferably reaches above 40%; and moreover, in connection with the strengthening mechanism such as microtwinning, the γ′ phase and the microtwinning are strengthened synergistically, obtaining the superalloy with an excellent high-temperature performance.

In a specific embodiment of the present application, a superalloy with low stacking fault energy includes, by mass fraction: 0.01%˜0.04% of C, 24%˜26% of Co, 12%˜14% of Cr, 1%˜1.5% of W, 2.5%˜3.0% of Mo, 2.3%˜2.5% of Al, 4.4%˜4.6% of Ti, 0.5%˜1.5% of Nb, 0.1%˜2.0% of Ta, 0.001%˜0.03% of B, 0.001%˜0.03% of Zr, 0%˜2.5% of Fe, 0%˜0.04% of Mg, and a balance of Ni. More preferably, a superalloy with low stacking fault energy includes, by mass fraction: 0.01%˜0.02% of C, 24%˜26% of Co, 12%˜13% of Cr, 1.1%˜1.3% of W, 2.7%˜2.9% of Mo, 2.3%˜2.5% of Al, 4.4%˜4.6% of Ti, 0.5%˜1.5% of Nb, 0.1%˜2.0% of Ta, 0.001%˜0.03% of B, 0.001%˜0.03% of Zr, 0%˜2.5% of Fe, and a balance of Ni.

The present application further provides a structural member made of any one of the above superalloy with low stacking fault energy.

In a specific embodiment of the present application, the structural member includes any one of a forging member, a casting member, and an additively manufactured structural member.

In a specific embodiment of the present application, a method for making the forging member includes:
(a) dosing according to ingredients of the superalloy with low stacking fault energy, and smelting the mixture to obtain an ingot; and
(b) performing homogenizing processing on the ingot, then making the same forged into a shape, and then performing thermal processing.

In a specific embodiment of the present application, the condition of the homogenizing processing includes: a heat preservation is carried out at 1100˜1150° C. for 24˜36 h, and then a heat preservation is carried out at 1170˜1190° C. for 36˜48 h.

In a specific embodiment of the present application, a method for making the casting member includes:
dosing according to ingredients of the superalloy with low stacking fault energy, performing a vacuum induction smelting, and then performing thermal processing after casting, to obtain the casting member.

In a specific embodiment of the present application, a method for making the additively manufactured structural member includes:
(a) dosing according to ingredients of the superalloy with low stacking fault energy, smelting the mixture to obtain an electrode rod, then pulverizing the same, and performing 3D printing according to the preset model; and
(b) performing hot isostatic pressing processing and thermal processing on the profile obtained by 3D printing.

In actual operations, the method for smelting and making powder (pulverizing) includes: preparing a master alloy with the vacuum horizontal continuous casting technology or the vacuum induction smelting technology, and making powder with the vacuum air atomization method. Optionally, 3D printing is carried out with the powder feeding or powder spreading selective laser melting technology.

In a specific embodiment of the present application, the condition of the hot isostatic pressing processing includes: a temperature of 1150 to 1200° C., a pressure not less than 120˜140 MPa, and a duration for heat and pressure preservation not less than 2 h.

In a specific embodiment of the present application, the condition of the thermal processing includes: solid solution processing is carried out at 1050˜1120° C. for 2˜6 h, air cooling is carried out to room temperature; then the temperature is heated to 600˜700° C., aging processing is carried out for 20˜30 h, then air cooling is carried out to room temperature, and then the temperature is heated to 700˜800° C. and aging processing is carried out for 10˜20 h, and then air cooling is carried out to room temperature.

The present application also provides use of any one of the above structural members in aviation and aerospace equipment.

### Examples 1˜7

Examples 1˜7 respectively provide 1 # to 7 # superalloys and method for making the same. The measured ingredients of the superalloy are shown in Table 1. In addition, the method for making the alloys in Comparison 1 #˜Comparison 3 # is the same as that of Examples 1-7, except that the ingredients of the superalloy are different.

The method for making a superalloy comprises the following steps.
(1) A certain amount of smelting raw materials that can obtain C, Co, Cr, W, Al, Ti, Nb, Ta, Mo, B, Zr, Fe, Mg, Hf and Ni elements was weighed in accordance with the principle of an element ratio of the superalloy, including base materials and volatile elements; the base materials were placed in a vacuum induction furnace crucible, and the volatile elements were placed in the feeder, and then vacuuming was carried out to start a vacuum induction melting. Power was up for heating up when the vacuum degree was less than 3 Pa, and then refining was carried out for 40 min after full melting (gradually reducing the power) until the power was off. When the molten steel was cooled to a certain temperature, Al, C, Ti, B, Hf, Mg, and the like were added for alloying, and power was off for cooling down after a full stirring; and power was up for forming an alloy ingot in case of a suitable temperature.
(2) After the alloy ingot was subjected to high-temperature homogenizing processing, a corresponding forging member was then obtained by forging and cogging, mold forging and forming as well as thermal processing.

The condition of the high-temperature homogenizing processing includes: a heat preservation was carried out at 1100˜1150° C. for 24 h, and then heat preservation was carried out at 1170˜1190° C. for 36 h; and the condition of the thermal processing includes: solid solution processing was carried out at 1050˜1100° C. for 2 h, air cooling was carried out to room temperature; then the temperature was heated to 600˜680° C., aging processing was carried out for 20 h, then air cooling was carried out to room temperature, and then temperature was heated to 750˜800° C. and aging processing was carried out for 10 h, and then air cooling was carried out to room temperature.

TABLE 1
Measured ingredients of the superalloy in different examples (wt %)

| No. | C | Co | Cr | W | Al | Ti | Nb | Ta | Mo | B | Zr | Fe | Mg | Ni |
|---|---|---|---|---|---|---|---|---|---|---|---|---|---|---|
| 1# | 0.02 | 25.1 | 12.8 | 1.22 | 2.42 | 4.51 | 1.21 | 0.82 | 2.81 | 0.018 | 0.028 | 1.04 | 0.02 | Balance |
| 2# | 0.015 | 25.3 | 12.9 | 1.04 | 2.49 | 4.53 | 0.55 | 0.26 | 3.03 | 0.019 | 0.027 | 0.96 | 0.02 | Balance |
| 3# | 0.02 | 24.9 | 12.8 | 1.19 | 2.21 | 3.52 | 0.75 | 0.40 | 2.83 | 0.020 | 0.028 | 1.02 | 0.02 | Balance |
| 4# | 0.02 | 26.8 | 12.8 | 0.53 | 2.42 | 4.52 | 1.22 | 0.83 | 2.11 | 0.018 | 0.025 | 1.05 | 0.02 | Balance |
| 5# | 0.02 | 25.2 | 12.9 | 1.23 | 2.43 | 5.42 | 1.19 | 0.79 | 2.77 | 0.018 | 0.027 | 1.02 | 0.02 | Balance |
| 6# | 0.02 | 24.9 | 12.9 | 1.22 | 2.41 | 4.48 | — | 2.52 | 2.82 | 0.018 | 0.026 | 0.98 | 0.02 | Balance |
| 7# | 0.02 | 25.2 | 12.8 | 1.18 | 2.38 | 4.53 | 2.53 | — | 2.81 | 0.019 | 0.029 | 0.99 | 0.02 | Balance |
| Comparison1# | 0.02 | 25.1 | 12.9 | 2.12 | 2.42 | 4.51 | 1.21 | 0.81 | 3.63 | 0.021 | 0.026 | 1.02 | 0.02 | Balance |
| Comparison2# | 0.02 | 24.8 | 12.8 | 1.22 | 2.39 | 4.50 | — | — | 2.81 | 0.019 | 0.028 | 0.97 | 0.02 | Balance |
| Comparison3# | 0.02 | 25.0 | 12.8 | 1.19 | 2.43 | 6.04 | 1.22 | 0.79 | 2.79 | 0.022 | 0.027 | 1.02 | 0.02 | Balance |

### Example 8

The present example provides a superalloy casting member with low stacking fault energy, and the method for making the same comprises the following steps.

Dosing was carried out by referring to the principle of the element ratio of thesuperalloy1 # in Example 1, casting was performed with the vacuum induction melting technology with a specific mold, and then the thermal processing was carried out to obtain a superalloy casting member. The condition of the thermal processing was as follows: a heat preservation was carried out at 1100˜1150° C. for 2 h and then air-cooling was carried out to room temperature, then a heat preservation was carried out at 1050˜1100° C. for 2 h, then air cooling was carried out to room temperature, then heating was carried out to 600˜680° C. and a heat preservation was carried out for 20 h, then air cooling was carried out, then heating was carried out to 750˜800° C. and a heat preservation was carried out for 10 h, and then air cooling was carried out to room temperature.

### Example 9

The present example provides a superalloy additively manufactured structural member with low stacking fault energy, and the method for making the same comprises the following steps.

Dosing was carried out by referring to the principle of the element ratio of the superalloy1 # in Example 1, the master alloy electrode was made with the vacuum induction smelting, and the powder was made with the vacuum gas atomization method; powder with the particle size in the range of 15˜53 μm was selected and made into a superalloy sample with selective laser melting technology (SLM); printing was carried out with a laser power of 160˜280 W, at a laser scanning speed of 800˜1300 mm/s, wherein a spot diameter was 80˜100 μm, a laser spacing was 90˜110 μm, and a powder spreading thickness was 30˜60 μm. Then the additively manufactured structural member was made by the hot isostatic pressing processing and the thermal processing.

The hot isostatic pressing processing is as follows: a heat preservation and pressure preservation was carried out at 1180˜1120° C. under 120˜140 MPa for 4˜6 h. The condition of the thermal processing includes: solid solution processing was carried out at 1050˜1100° C. for 2 h, air cooling was carried out to room temperature; then heating was carried out to 600˜680° C., aging processing was carried out for 20 hours, air cooling was carried out to room temperature, and then heating was carried out to 750˜800° C. and aging processing was carried out for 10 h, and air cooling was carried out to room temperature.

### Experimental Example 1

Microstructure of the superalloy was observed with a high-resolution transmission electron microscope, and the typical structure of the superalloy was characterized.

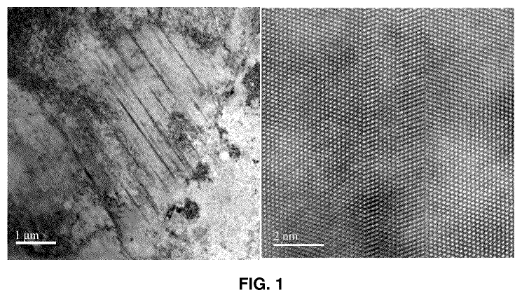

Taking superalloy1 # as an example, the microstructure photo thereof is shown in FIG. 1. As can be seen from the figure, the superalloy of the present application has low stacking fault energy and has microstructures such as microtwinning easily occurred.

### Experimental Example 2

According to the standards “GB/T 228.2˜2015 Metallic Material Tensile Test Part 2: High-Temperature Test Method” and “GB/T2039˜2012 Metallic Material Uniaxial Tensile Creep Test Method,” test results of the mechanical performance of 1 #˜7 #superalloy forging members made in Examples 1-7 and their comparative alloys 1 #˜3 # superalloy forging members, and of 1 # alloy casting member and additively manufactured structural member made in Example 8 and Example 9, respectively as well as the plasticity of different alloys at 1150° C. were shown in Table 2. The process performance of the alloy was characterized by the high-temperature plasticity in the course of the thermal processing.

TABLE 2
Test results of tensile performance, durability and lifetime, high-temperature
plasticity and thermal stability of different superalloys

| | | | | | after aging |
|---|---|---|---|---|---|
| | | | | | processing for 1000 |
| | | | 750° C./530 | | h at 750° C., whether |
| | 750° C. tensile | | MPa durability | 1150° C. | there is TCP phase |
| No. | σ_{b}/MPa | σ_{0.2}/MPa | and lifetime τ/h | plasticity | precipitated |
| 1# Forging | 1211 | 1083 | 285 | 51% | None |
| member | | | | | |
| 1# Casting | 1088 | 974 | 298 | / | None |
| member | | | | | |
| 1# additively | 1197 | 1072 | 270 | / | None |
| manufactured | | | | | |
| structural member | | | | | |
| 2# Forging | 1171 | 1054 | 246 | 44% | None |
| member | | | | | |
| 3# Forging | 1169 | 1056 | 213 | 48% | None |
| member | | | | | |
| 4# Forging | 1177 | 1072 | 261 | 52% | None |
| member | | | | | |
| 5# Forging | 1210 | 1080 | 224 | 49% | None |
| member | | | | | |
| 6# Forging | 1180 | 1077 | 242 | 42% | None |
| member | | | | | |
| 7# Forging | 1178 | 1074 | 238 | 44% | None |
| member | | | | | |
| Comparison 1# | 1172 | 1059 | 118 | 32% | There is μ phase |
| Forging member | | | | | precipitated |
| Comparison 2# | 1120 | 1012 | 102 | 20% | None |
| Forging member | | | | | |
| Comparison 3# | 1184 | 1082 | 151 | 22% | There is η phase |
| Forging member | | | | | precipitated |

Finally, it should be noted that the above examples are only used to illustrate the technical solutions of the present application, rather than limiting the same; although the present application has been described in detail with reference to the foregoing examples, those ordinarily skilled in the art should understand that: it is still possible to modify the technical solutions described in the foregoing examples or equivalently replace some or all of the technical features therein; and these modifications or replacements do not deviate the essence of the corresponding technical solutions from the scope of the technical solutions of the examples of the present application.

### INDUSTRIAL APPLICABILITY

The present application provides a superalloy with low stacking fault energy, a structural member comprising the superalloy with low stacking fault energy, and use thereof. The superalloy with low stacking fault energy can be cast, forged, welded, printed, and so on; it has an excellent process performance, and can be suitable for making structural members in aviation and aerospace equipment, for example it can be used as structural members for long-term use for example a turbine disc, a blade, a casing, and a combustion chamber and the like.

In addition, it should be understood that the superalloy with low stacking fault energy, and the structural member comprising the superalloy with low stacking fault energy provided by the present application can be used in industrial applications and are reproducible.

1. A superalloy with low stacking fault energy, comprising, by mass fraction, 0.01%˜0.09% of C, 23.5%˜27.5% of Co, 12%˜15% of Cr, 0.1%˜1.8% of W, 2.2%˜2.6% of Al, 3.5%˜5.5% of Ti, 0%˜2% of Nb, 0%˜2% of Ta, 2.1%˜3.5% of Mo, 0.0001%˜0.05% of B, 0.0001%˜0.05% of Zr, 0%˜2.5% of Fe, 0%˜0.04% of Mg, and a balance of Ni,
wherein a sum of mass fractions of Nb and Ta is ≥0.8%;
a ratio of a sum of the mass fractions of Nb and Ta to a mass fraction of the Al element is ≥0.4; and a ratio of a mass fraction of Ti to the mass fraction of Al is ≤2.1; and
a volume fraction of γ′ strengthening phase is above 30%.

2. The superalloy with low stacking fault energy according to claim 1, wherein a mass fraction of Co is 23.5%˜26.5%.

3. (canceled)

4. The superalloy with low stacking fault energy according to claim 1, wherein a sum of mass fractions of W and Mo is ≥3%; and
a mass fraction of W is 1%˜1.8%; and a mass fraction of Mo is 2.1%˜3.0%.

5. (canceled)

6. (canceled)

7. The superalloy with low stacking fault energy according to claim 1, wherein a sum of mass fractions of Al, Ti, Nb and Ta is ≥7%.

8. The superalloy with low stacking fault energy according to claim 7, comprising, by mass fraction, 0.01%˜0.04% of C, 24%˜26% of Co, 12%˜14% of Cr, 1%˜1.5% of W, 2.5%˜3.0% of Mo, 2.3%˜2.5% of Al, ˜4.4%˜4.6% of Ti, 0.5%˜1.5% of Nb, 0.1%˜2.0% of Ta, 0.001%˜0.03% of B, 0.001%˜0.03% of Zr, 0%˜2.5% of Fe, 0%˜0.04% of Mg, and a balance of Ni.

9-12. (canceled)

13. A structural member, wherein the structural member is made by the superalloy with low stacking fault energy according to claim 1,
wherein the structural member comprises any one of a forging member, a casting member, and an additively manufactured structural member.

14. The structural member according to claim 13, wherein the structural member comprises any one of a turbine disc, a blade, a casing, and a combustion chamber.

15. (canceled)
